(19) United States
(12) Patent Application Publication
(10) Pub. No.: US 2016/0356291 A1
(43) Pub. Date: Dec. 8, 2016

(54) COMPRESSION LIMITER

(71) Applicants: DENSO International America, Inc., Southfield, MI (US); DENSO CORPORATION, Kariya-city (JP)

(72) Inventors: Mark Williams, Gaines, MI (US); Blaise DiDonato, Waterford Township, MI (US)

(21) Appl. No.: 14/729,292

(22) Filed: Jun. 3, 2015

(51) Int. Cl. F16B 1/00; F16B 43/00

(52) U.S. Cl. CPC F16B 1/00; F16B 43/00; F16B 2001/0092

(57) ABSTRACT

A compression limiter for limiting compressive force applied by a fastener when fastening a component to a body. The compression limiter includes a sleeve and a diaphragm. The sleeve is formed in a cylindrical shape with openings at both ends. The diaphragm is coupled to an inner surface of the sleeve. The diaphragm is deformable between a first configuration and a second configuration. The first configuration defines a slit on the diaphragm with a width less than a diameter of the fastener. The second configuration expands the slit according to the diameter of the fastener so that the fastener is retained within the sleeve because of an elastic force applied by the diaphragm.

### TECHNICAL FIELD

The present disclosure relates to a compression limiter.

### BACKGROUND

This section provides background information related to the present disclosure which is not necessarily prior art.

A compression limiter is a non-threaded insert designed to protect a component from compressive force generated by tightening a fastener. When fastening the component to a body by the fastener, the compression limiter is interposed between the fastener and a through hole of the component. The fastener is inserted into the compression limiter and screwed into a threaded hole formed in the body. The compression limiter has a length almost equal to or slightly less than a thickness of the compression limiter. Therefore, the compressive force is applied limitedly to the component while the compression limiter is rigidly sandwiched between a head of the fastener and a surface of the body. This technique prevents the component from damage or crack due to an overload of stress.

An example of the compression limiter is disclosed in U.S. Pat. No. 6,457,925 B1. This compression limiter has a fastener retainer to prevent the fastener from falling out of a longitudinal sleeve before securing one work piece to another. However, the fastener retainer is designed for a specific fastener and not available for other fasteners having different diameters.

### SUMMARY

It is an object of the present disclosure to provide a fastening device integrated with an alignment feature that ensures a proper alignment in assembling.

It is therefore an aspect of the present disclosure to provide a compression limiter for limiting compressive force applied by a fastener when fastening a component to a body. The compression limiter includes a sleeve and a diaphragm. The sleeve is formed in a cylindrical shape with openings at both ends. The diaphragm is coupled to an inner surface of the sleeve. The diaphragm is deformable between a first configuration and a second configuration. The first configuration defines a slit on the diaphragm with a width less than a diameter of the fastener. The second configuration expands the slit according to the diameter of the fastener so that the fastener is retained within the sleeve because of an elastic force applied by the diaphragm.

### BRIEF DESCRIPTION OF THE DRAWINGS

The above and other objects, features and advantages of the present invention will become more apparent from the following detailed description made with reference to the accompanying drawings. In the drawings:

FIG. 1 is a perspective view showing a compression limiter with a slit;

FIG. 2 is a cross sectional view taken along line 2-2 of FIG. 1;

FIG. 3 is an explanation view showing the way in which a fastener is assembled to the compression limiter;

FIG. 4 is a top view of the compression limiter having a rectangular-shaped slit in a first configuration;

FIG. 5 is a top view of the compression limiter having a rectangular-shaped slit in a second configuration;

FIG. 6 is a cross sectional view of the compression limiter with the fastener having a large diameter;

FIG. 7 is a cross sectional view of the compression limiter with a fastener having a small diameter;

FIG. 8 is a top view of the compression limiter having a rhombus-shaped slit;

FIG. 9 is a top view of the compression limiter having an elliptical-shaped slit; and

FIG. 10 is a top view of the compression limiter having a star-shaped slit.

### DETAILED DESCRIPTION

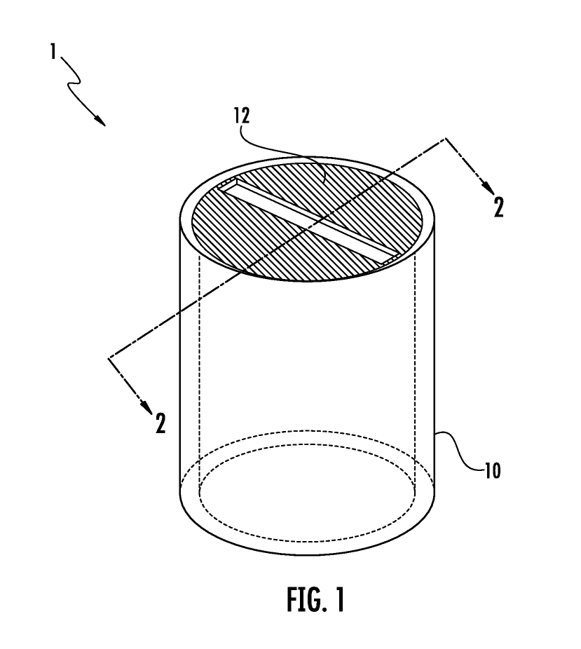

An embodiment of the present disclosure is described referring to the drawings. An perspective view of FIG. 1 shows a compression limiter 1. The compression limiter 1 includes a sleeve 10 and a diaphragm 12 inside of the sleeve 10. The sleeve 10 has a cylindrical shape with openings at both ends. The sleeve 10 may be made from a metal material that has a high-bearing capacity from compressive force especially in a longitudinal direction.

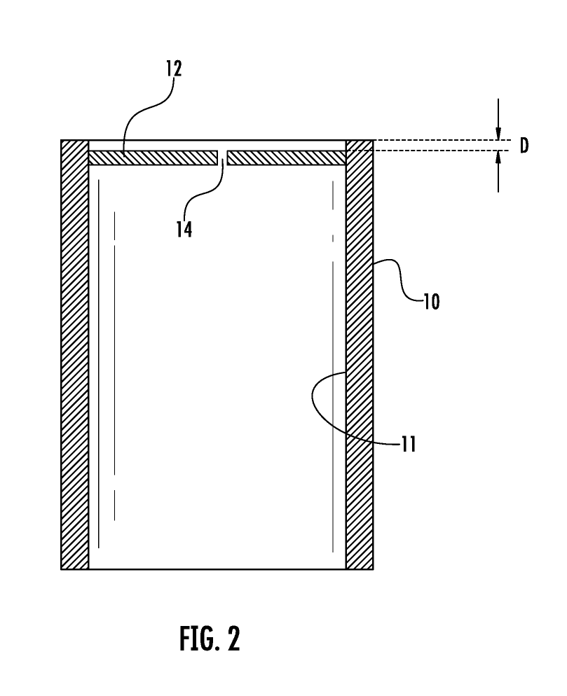

With referring to FIG. 2 showing a cross sectional view taken along line 2-2 of FIG. 1, the diaphragm 12 is coupled to or integrally molded with an inner surface 11 at a distance D away from the near end of the sleeve 10. The distance D may be approximately between 1 mm and 1 cm so that the diaphragm 12 never interferes with other parts of the assembly (e.g. a fastener). The diaphragm 12 defines a slit 14 on its surface. The diaphragm 12 includes a pair of flaps which protrudes from the inner surface 11 towards each other and defines the slit 14 therebetween. The diaphragm 12 may be made from elastomeric or rubber material that has elastic properties and thus deformable. The diaphragm 12 may be formed as one piece or formed as two or more pieces including the pair of flaps.

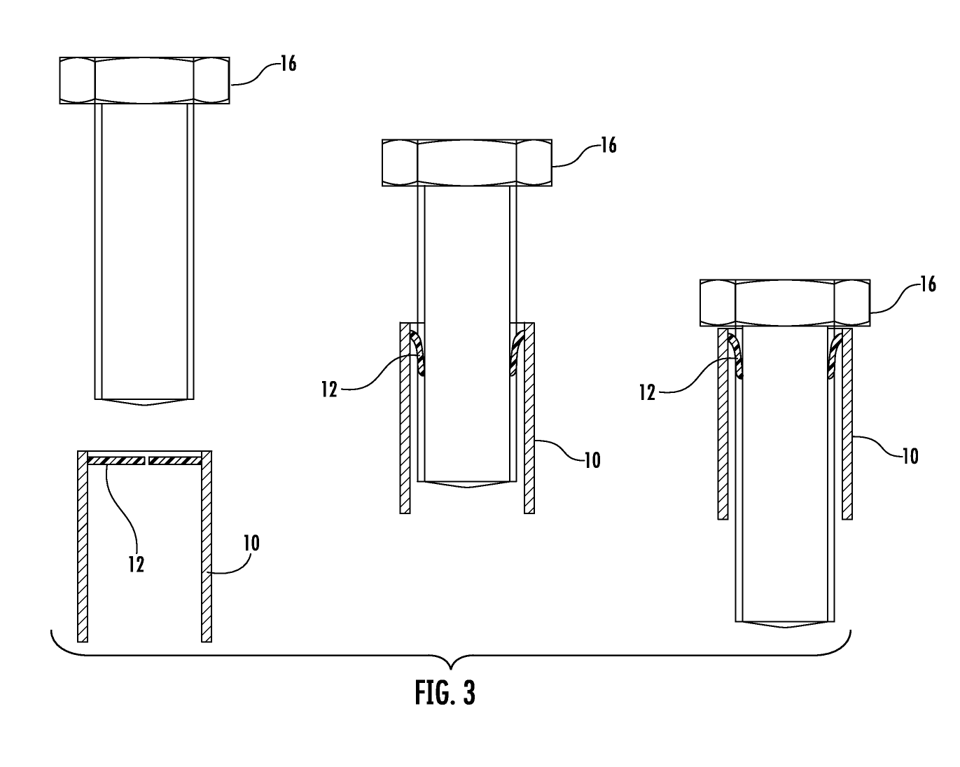

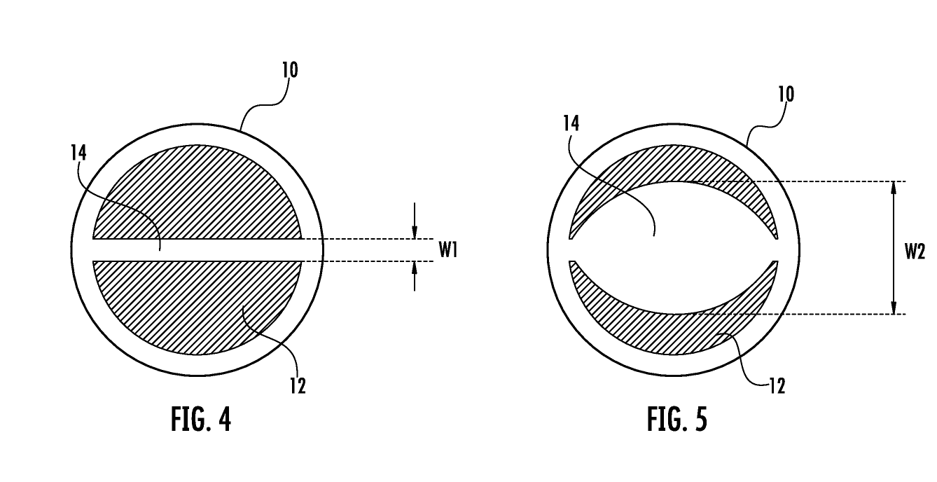

The deformation of the diaphragm 12 is illustrated in FIG. 3. Before assembling with a fastener 16, the compression limiter 1 has the diaphragm 12 in a first configuration (left of FIG. 3). In the first configuration, the diaphragm 12 is almost parallel to the opening edge of the sleeve 10. As shown in FIG. 4, the pair of flaps of the diaphragm 12 has symmetrical semicircular shapes that define the slit 14 in a rectangular shape with a width W1 therebetween. The width W1 is set less than the diameter of the fastener 16. The fastener 16 may be a bolt, a stud, or a pin.

The fastener 16 is inserted into the sleeve 10 from one side of the openings. Once a tip portion of the fastener 16 penetrates the slit 14 defined between the pair of the flaps 12, the slit 14 is expanded due to the size difference from the diameter of the fastener 16. The diaphragm 12 is elastically bent towards the other side of the openings of the sleeve 10 due to insertion of the fastener 16 and thus deformed in a second configuration (center of FIG. 3). As shown in FIG. 5, the diaphragm 12 is deformed to symmetrical crescent shapes to expand the slit 14 to a width W2. The width W2 is according to the diameter of the fastener 16. Edges of the diaphragm 12 interact with threads of the fastener 16 and retain the fastener 16 because of its elastic force to prevent from falling out of the sleeve 10 (right of FIG. 3).

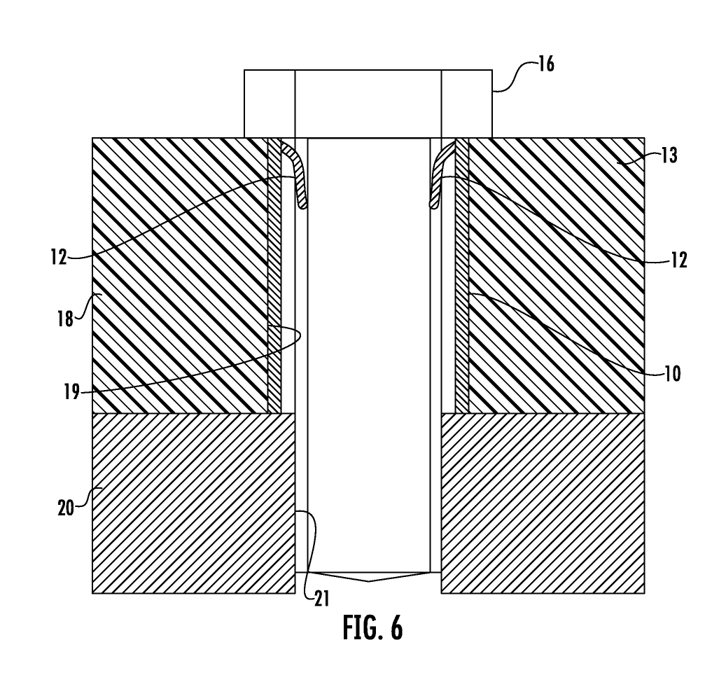

After assembling the compression limiter 1 with the fastener 16, they are employed to fasten a component 18 to a body 20 as shown in FIG. 6. The component 18 has a through hole 19 which diameter is almost equal to or larger than the sleeve 10. The thickness of the component 18 is almost equal to or slightly larger than the length of the sleeve 10. The body has a threaded hole 21 that receives the fastener 16. By screwing the fastener 16 into the threaded hole 21 through the through hole 19, the component 18 is fastened to the body 19. The more the fastener 16 is screwed, the more the compressive force is applied to the component 18. However, the compressive force is limited because of the compression limiter 1 so that no overload is applied to the component 18 that may cause crack or damage.

FIG. 7 shows an example of the compression limiter 1 assembled with a fastener 22 whose diameter is smaller than that of the fastener 16. Despite the size difference, the diaphragm 12 deforms according to the diameter of the fastener 22 to retain the fastener 22 within of the sleeve 10. Any other fastener having different diameter as long as it is thinner than the sleeve 10 and thicker than the slit 14 may be applicable to the compression limiter 1.

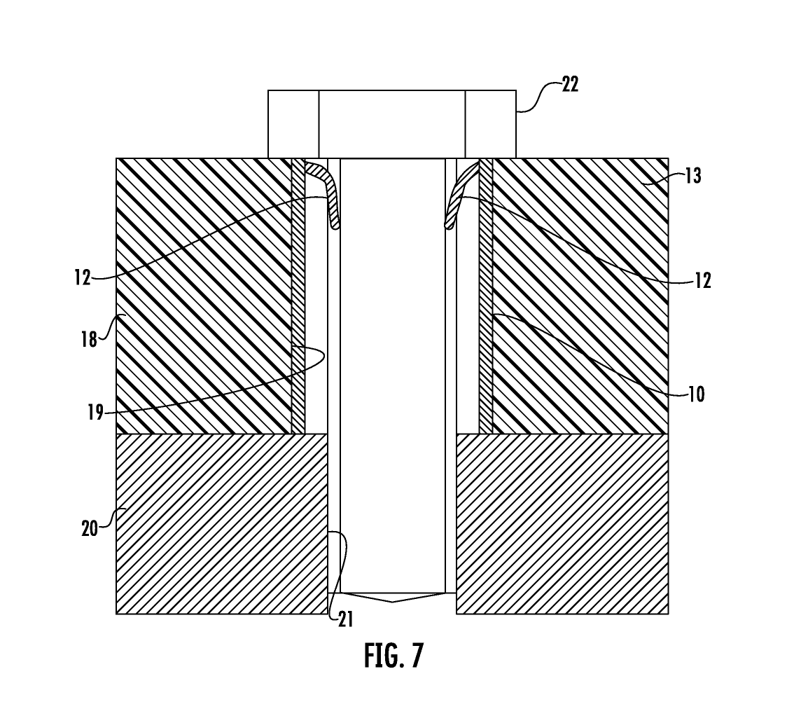

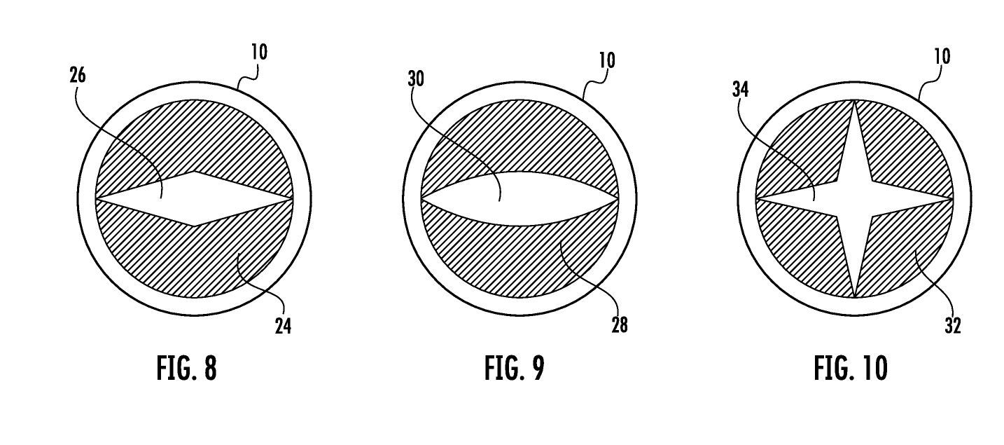

FIGS. 8 to 10 show other embodiments of the slit 14. The slit 14 may be alternated with a rhombs-shaped slit 26 defined by a diaphragm 24, an elliptical-shaped slit 30 defined by a diaphragm 28, or a star-shaped slit 34 defined by a diaphragm 32. Any other variations of the slit 14 may be applicable to retain the fastener 16, 22 within the sleeve 10.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A compression limiter for limiting compressive force applied by a fastener when fastening a component to a body, the compression limiter comprising:
a sleeve formed in a cylindrical shape with openings at both ends; and
a diaphragm coupled to an inner surface of the sleeve, wherein
the diaphragm is deformable between a first configuration which defines a slit on the diaphragm with a width less than a diameter of the fastener and a second configuration which expands the slit according to the diameter of the fastener so that the fastener is retained within the sleeve because of an elastic force applied by the diaphragm.

2. The compression limiter according to claim 1, wherein the diaphragm is located at a distance away from an end of the sleeve.

3. The compression limiter according to claim 1, wherein the diaphragm is elastically bent with expanding the slit.

4. The compression limiter according to claim 1, wherein the diaphragm is molded inside of the sleeve.

5. The compression limiter according to claim 1, wherein the diaphragm is made from elastomeric or rubber material.

6. The compression limiter according to claim 1, wherein the slit is formed in a rectangular shape in the first configuration.

7. The compression limiter according to claim 1, wherein the slit is formed in a rhombs shape in the first configuration.

8. The compression limiter according to claim 1, wherein the slit is formed in an elliptical shape in the first configuration.

9. The compression limiter according to claim 1, wherein the slit is formed in a star shape in the first configuration.

10. The compression limiter according to claim 1, wherein the diaphragm includes a pair of flaps defining the slit therebetween in the first configuration.

11. The compression limiter according to claim 1, wherein the fastener is a bolt, a stud, or a pin.
